(19) United States
(12) Patent Application Publication
(10) Pub. No.: US 2026/0072243 A1
(43) Pub. Date: Mar. 12, 2026

(54) ACTUATOR FOR CAMERA

(71) Applicant: JAHWA electronics Co., Ltd., cheongju-si (KR)

(72) Inventors: Hee Seung KIM, cheongju-si (KR); In Soo KIM, cheongju-si (KR); Ki Hoon JEON, cheongju-si (KR)

(21) Appl. No.: 19/284,593

(22) Filed: Jul. 29, 2025

(30) Foreign Application Priority Data
Sep. 10, 2024 (KR) 10-2024-0123336

(51) Int. Cl. G02B 7/182; G02B 27/64

(52) U.S. Cl. CPC G02B 7/1827; G02B 27/646

(57) ABSTRACT

An actuator for a camera according to an embodiment of the present disclosure includes a carrier configured to move linearly; a housing configured to support linear movement of the carrier, a plurality of rails provided on at least one of the carrier and the housing; and a plurality of balls arranged on each of the plurality of rails, and in this case, at least one more ball is arranged on a first rail among the plurality of rails than the number of balls arranged on the other rails.

### TECHNICAL FIELD

The present disclosure relates to an actuator for a camera, and more specifically, to an actuator for a camera, which has improved durability and driving precision through structural improvements for linear movement of a carrier.

### BACKGROUND ART

Advances in hardware technology for image processing and growing consumer need for making and taking photos and videos have driven implementation of such functions as autofocusing (AF) and optical image stabilization (OIS) in stand-alone cameras as well as camera modules mounted on mobile terminals including cellular phones and smartphones.

An autofocus (AF) function (or, an automatically focusing function) means a function of a focal length to a subject by linearly moving a carrier having a lens in an optical axis direction to generate a clear image at an image sensor (CMOS, CCD, etc.) located at the rear of the lens.

An optical image stabilization (OIS) function means a function of improving the sharpness of an image by adaptively moving the carrier having a lens in a direction to compensate for the shaking when the lens is shaken due to trembling.

One typical method for implementing the AF or OIS function is to install a magnet (a coil) on a mover (a carrier) and install a coil (a magnet) on a stator (a housing, or another type of carrier, or the like), and then generate an electromagnetic force between the coil and the magnet so that the mover moves in the optical axis direction or in a direction perpendicular to the optical axis.

Recently, actuators or camera modules that use a reflector placed at the front end of the lens to reflect (refract) light from a subject in order to organically integrate the physical characteristics of a zoom lens into the morphological characteristics of a portable terminal have been disclosed.

The actuator using a reflector implements OIS by rotating or moving the reflector along one or two axes, and implement AF or zoom functions by linearly moving a carrier equipped with a lens, etc.

In the case of the actuator, the moving distance (stroke) of the carrier in the optical axis direction through AF or zoom control is relatively longer than the moving distance (stroke) of other types of actuators, and a heavy lens may be mounted depending on the optical specifications.

If an external force such as an external shock or hand trembling is applied to the actuator, a physical shock may occur between the housing (case, base, etc.) and the carrier, which are separated from each other.

The internal components of the actuator vary in structure and shape, and are made of different materials such as plastic, metal, and ceramic. In the case of an actuator with specifications such as high weight and long stroke, the physical impact is greater, so noise increases, and also wear, damage, and destruction of the internal components may occur more easily and significantly.

In particular, if the physical impact is large, the surface of the ball that guides the physical movement between the housing and the carrier or the surface of the carrier or housing that comes into contact with the ball may be dug or damaged (to create a dent), and when a dent occurs in the ball, etc., the tilt or poor posture of the carrier may occur, and it also becomes difficult to precisely implement the linear movement of the carrier.

If wear or damage occurs to the internal components, the possibility of malfunction increases, and foreign substances such as particles (particles, debris, etc.) detached from the internal components may be generated and scattered, which may reduce operating precision and significantly affect image quality, such as the generation of dead pixels in image pickup devices such as CCDs.

### SUMMARY

### Technical Problem

The present disclosure is designed to solve the problems of the related art, and therefore the present disclosure is directed to providing an actuator for a camera, which may enhance durability as well as improve the posture stability and driving precision of a carrier by improving the structure for physical support and guiding of the carrier.

Other technical goals and advantages of the present invention can be understood with reference to the description below, which will be made explicit by the accompanied examples. Furthermore, the technical goals and advantages of the present invention can be accomplished by the embodiments and their combinations recited in the attached claims.

### Technical Solution

An actuator for a camera according to an embodiment of the present disclosure to accomplish the above object comprises a carrier configured to move linearly; a housing configured to support linear movement of the carrier; a plurality of rails provided on at least one of the carrier and the housing; and a plurality of balls arranged on each of the plurality of rails, wherein at least one more ball is arranged on a first rail among the plurality of rails than the number of balls arranged on the other rails.

Specifically, a length of the first rail of the present disclosure may be longer than a length of the other rails, and the first rail may have a U-shaped cross section.

In addition, the actuator for a camera according to an embodiment of the present disclosure may further comprise a driving magnet mounted on the carrier; a coil provided in the housing to face a first surface of the driving magnet; and a magnetic body provided in the housing to face a second surface, which is a surface of the driving magnet that is perpendicular to the first surface, and configured to generate an attractive force with the driving magnet.

In this case, the driving magnet of the present disclosure may be mounted on the carrier such that both the first surface and the second surface are exposed to the outside, and the magnetic body of the present disclosure may have a shape extending in a moving direction of the carrier and may be provided at an outer side than the plurality of rails.

Preferably, the first rail of the present disclosure may be provided on at least one of one side of a lower portion of the carrier and one side of a bottom surface of the housing, and the plurality of rails of the present disclosure may include a second rail provided in parallel with the first rail on at least one of the other side of the lower portion of the carrier and the other side of the bottom surface of the housing, and the second rail is provided in plurality on the same line.

In addition, the plurality of balls of the present disclosure may include a ball arranged on the first rail; and a single ball respectively arranged on the second rail and having a diameter larger than a diameter of the ball arranged on the first rail.

Depending on an embodiment, the actuator for a camera according to an embodiment of the present disclosure may further comprise a first magnetic body provided on the carrier at a position closer to the second rail than the first rail; and a second magnetic body provided on the housing to face the first magnetic body and configured to generate an attractive force with the first magnetic body.

In addition, the actuator for a camera according to an embodiment of the present disclosure may further comprise a coil provided in the housing; and a driving magnet mounted on the carrier to face the coil and provided at a position closer to the second rail than to the first rail.

Preferably, an imaginary line connecting centers of the balls placed on the second rail may be located within a thickness range of the driving magnet.

Depending on an embodiment, the actuator for a camera according to an embodiment of the present disclosure may further comprise a mounter on which a lens is mounted; a first support portion provided at one side of the mounter and having a shape extending in an optical axis direction so that the driving magnet is installed thereon; and a second support portion provided at the other side of the mounter and having a shape extending in the optical axis direction in a direction opposite to the extension direction of the first support portion.

In this case, the first rail of the present disclosure may be provided on a lower portion of the second support portion, and the plurality of rails of the present disclosure may include a second rail provided on a lower portion of the first support portion in parallel with the first rail and provided in plurality on the same line.

### Advantageous Effects

According to an embodiment of the present disclosure, by differentially applying the arrangement and number of balls that physically support the carrier at different locations, the physical guiding of the carrier may be effectively achieved, while damage and wear of balls, etc. due to external impact may be more effectively reduced.

According to an embodiment of the present disclosure, a ball located at one side is induced to always contact the carrier, and by arranging a plurality of balls at the other side where clearance may occur, both shock absorption and operating precision may be effectively implemented.

According to an embodiment of the present disclosure, the carrier is supported at three positions as a whole by balls, but by inducing physical contact with the carrier to be variably formed by a plurality of balls located at one side, changes in contact points by the balls may be minimized, thereby effectively reducing tilt and poor posture of the carrier.

According to an embodiment of the present disclosure, the linear movement of the carrier may be implemented more stably by structurally improving the relationship between the portion where the driving force is generated by the magnet, the linear movement line of the carrier, and the linear line where the carrier is physically supported by the ball.

### BRIEF DESCRIPTION OF DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIGS. 1, 2 and 3 are drawings showing an overall configuration of an actuator for a camera and a camera module according to a preferred embodiment of the present disclosure,

FIG. 4 is a drawing showing a detailed configuration of a reflector module according to a preferred embodiment of the present disclosure,

FIG. 5 is a drawing for explaining a detailed configuration of an actuator for a camera according to the present disclosure,

FIG. 6 is a drawing for explaining a detailed configuration of a ball and a rail according to an embodiment of the present disclosure,

FIGS. 7 and 8 are drawings for explaining a detailed configuration of a ball and a rail according to another embodiment of the present disclosure,

FIG. 9 is a drawing for explaining a rail structure provided in a housing and a carrier,

FIG. 10 is a drawing for explaining a structure of a magnetic body according to an embodiment of the present disclosure,

FIG. 11 is a drawing for explaining a carrier according to an embodiment of the present disclosure,

FIGS. 12 and 13 are drawings for explaining a structural relationship between a driving magnet and a magnetic body according to an embodiment of the present disclosure,

FIG. 14 is a drawing for explaining a relationship between a driving magnet and a ball according to an embodiment of the present disclosure,

FIG. 15 is a drawing for explaining a structure of a carrier according to another embodiment of the present disclosure, and

FIG. 16 is a drawing showing an overall configuration of an actuator for a camera according to another embodiment of the present disclosure.

### DETAILED DESCRIPTIONS OF EXEMPLARY EMBODIMENTS

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the description proposed herein is just a preferable example for the purpose of illustrations only, not intended to limit the scope of the disclosure, so it should be understood that other equivalents and modifications could be made thereto without departing from the scope of the disclosure.

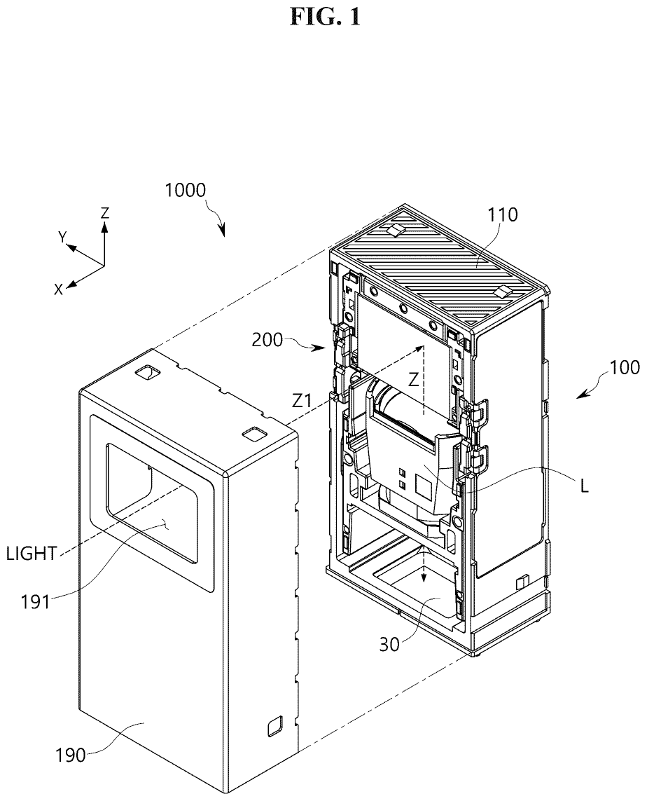

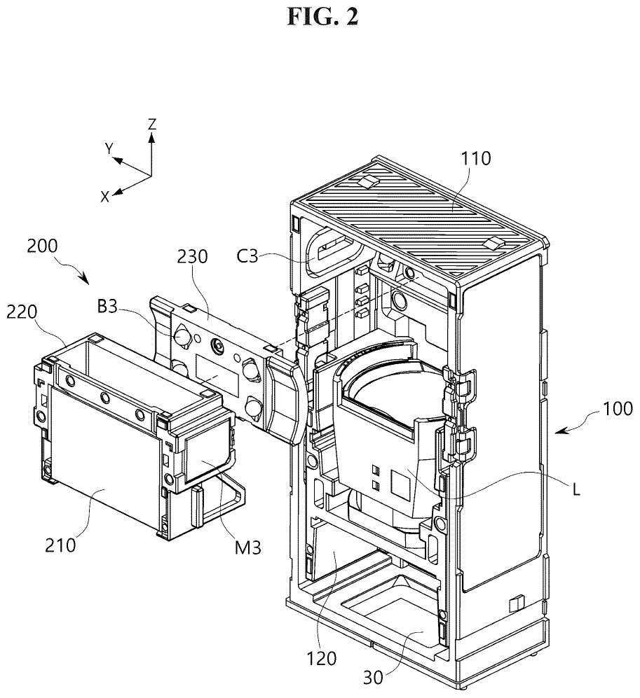

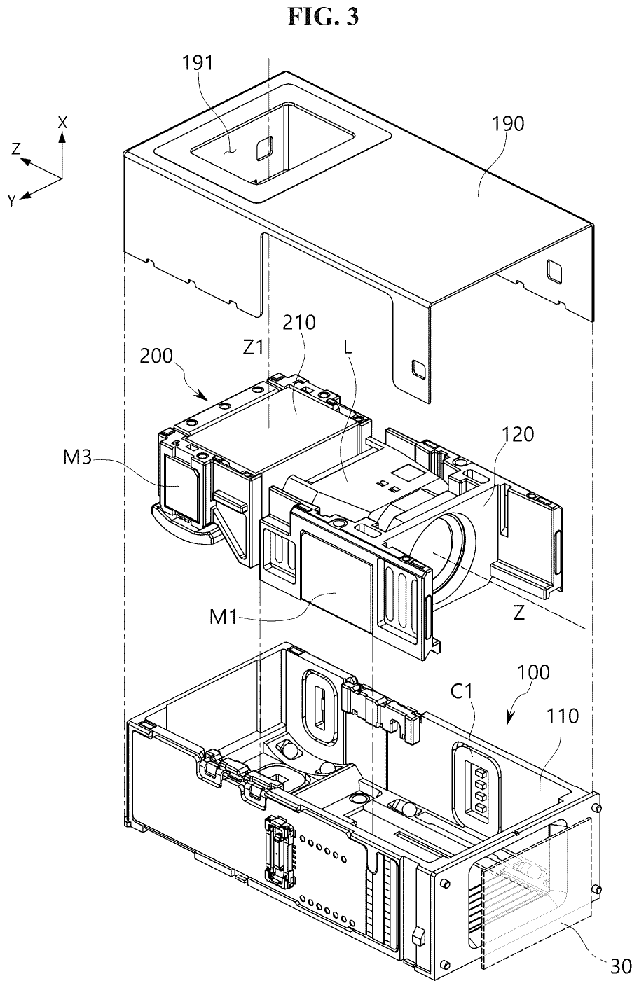

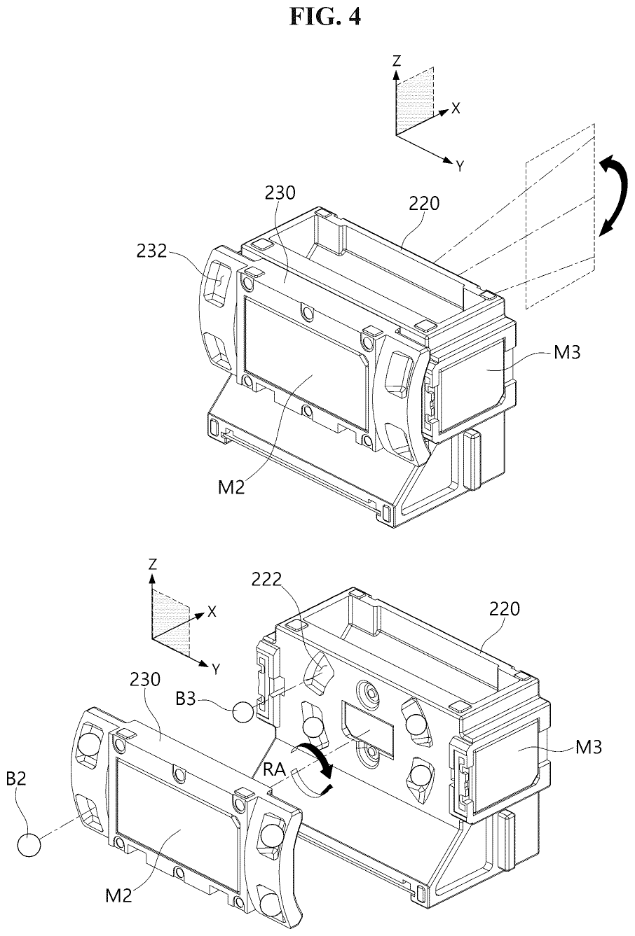

FIGS. 1 to 3 are drawings showing an overall configuration of an actuator 100 for a camera (hereinafter, referred to as an ‘actuator’) and a camera module 1000 according to a preferred embodiment of the present disclosure, and FIG. 4 is a drawing showing a detailed configuration of a reflector module 200 according to a preferred embodiment of the present disclosure.

The actuator 100 of the present disclosure may be implemented as a single device in itself, and may also be implemented as a camera module 1000 including the reflector module 200, etc., as shown in FIG. 1.

The actuator 100 of the present disclosure may be an actuator that implements auto focus (AF) or zoom by linearly moving a carrier 120 equipped with a lens, a lens module or a lens assembly (hereinafter, referred to as “lens”) L in an optical axis direction, etc.

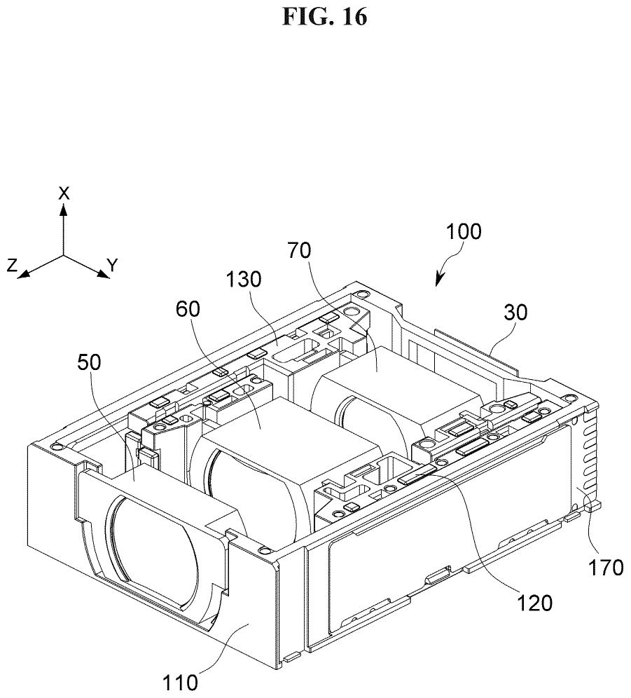

Although the drawings depict a single carrier 120, depending on an embodiment, a plurality of carriers 120, 130 may be included in the actuator 100 of the present disclosure, as exemplified in FIG. 16.

The reflector module 200, which may be installed in front of the actuator 100 (based on the optical axis direction), performs the function of reflecting or refracting the light path Z1 of a subject into the path Z in the direction toward the lens L if light enters through the opening 191 formed in the case 190, which functions as a shield can, etc. The light reflected or refracted in the optical axis direction in this way passes through the lens L and enters the image sensor 30, such as a CMOS or CCD.

The reflector module 200 that changes the path of light may include a reflector 210 that may be formed of one selected from a mirror or a prism, or a combination thereof. The reflector 210 may be implemented by various members that may change light coming from the outside to the optical axis direction, but it is preferable that the reflector 210 is made of a glass material in order to improve optical performance.

The camera module 1000 of the present disclosure, which includes the reflector module 200, etc., is configured to refract the light path so that light enters toward the lens, and thus the device itself may be installed in the length direction rather than the thickness direction of the mobile terminal, and thus may be optimized for miniaturization or slimming of the mobile terminal.

According to an embodiment, the reflector 210 may be configured to rotate by a driving means that generates a magnetic force, such as a magnet and a coil. If the reflector 210 moves or rotates in this way, the light of the subject reflected (refracted) through the reflector 210 moves in the +Y direction and/or +X direction and is incident on the image sensor 30, so that correction for the X-axis and/or Y-axis direction due to hand trembling may be implemented.

Specifically, the reflector module 200 may be configured to include a rotation carrier 220 and a middle guide 230 on which the reflector 210 is installed.

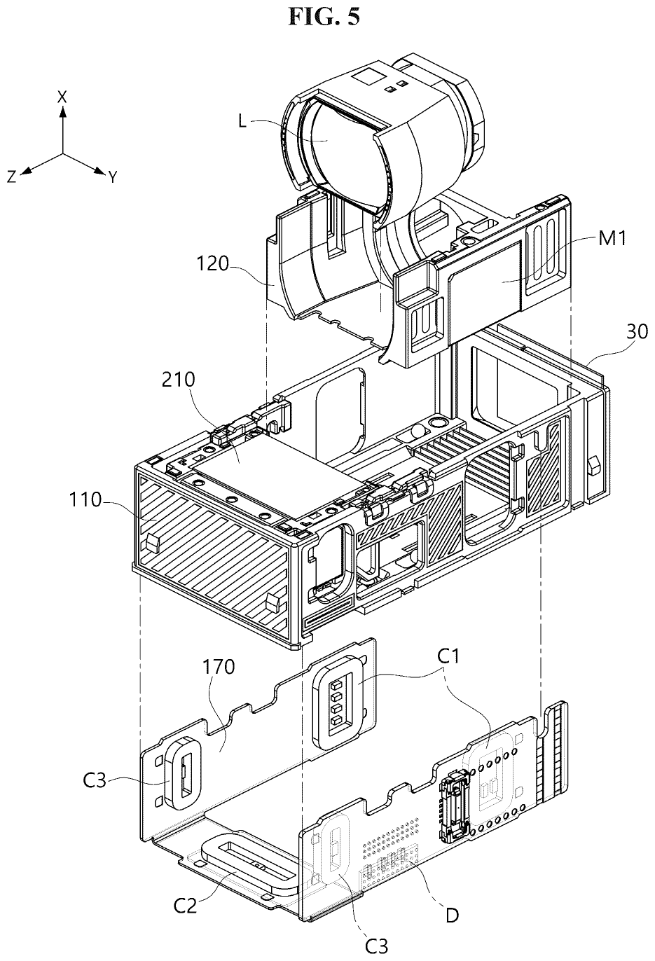

The rotation carrier 220 is configured to rotate with respect to the middle guide 230 if a magnetic force (electromagnetic force) is generated between the third magnet M3 installed in the rotation carrier 220 and the third coil C3 (see FIG. 5) installed on the housing 110. In the drawings, as an embodiment, an example is shown in which the rotation carrier 220 with the middle guide 230 as a relatively stator rotates with respect to the YZ plane (see FIG. 4).

If the rotation carrier 220 rotates around the YZ plane, namely the X-axis direction RA (see FIG. 4), as above, the reflector 210 also rotates in the same direction along with the physical movement.

Since the reflector 210 has an inclined surface on which the light of the subject is reflected, if the reflector 210 rotates based on the YZ plane, the path of the light entering the image sensor 30 moves in the Y-axis direction, thereby correcting the hand trembling in the Y-axis direction.

According to an embodiment, at least one of the middle guide 230 and the rotation carrier 220 may have a guiding rail 222 formed on a surface where the middle guide 230 and the rotation carrier 220 face each other to accommodate or guide the third ball B3.

Meanwhile, when a magnetic force (electromagnetic force) is generated between the second magnet M2 and the second coil C2 (see FIG. 5) installed in the middle guide 230, the middle guide 230 rotates around the XZ plane in a state where the rotation carrier 220 is mounted thereon.

If the middle guide 230 rotates based on the XZ plane inn this way, the reflector 210 also rotates in the same manner, so the path of light entering the image sensor 30 moves (shifts) in the X-axis direction, thereby correcting the hand trembling of the X-axis direction component.

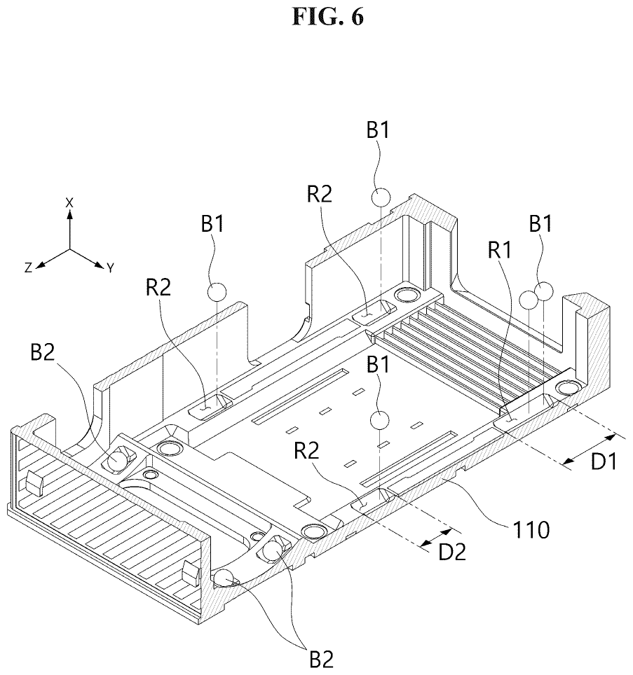

As illustrated in the drawings, a guiding rail 232 having a rounded shape may be provided on the rear surface of the middle guide 230 to guide the rotation (based on the XZ plane) of the middle guide 230. The second ball B2 (see FIGS. 4 and 6, etc.) may be arranged so that a portion thereof is accommodated in the guiding rail 232.

The light of the subject reflected through the reflector module 200 is incident on the lens L provided inside the actuator 100, and the position of the lens L (based on the optical axis direction) is adjusted by the actuator 100 of the present disclosure, thereby implementing functions such as zoom or AF.

The image sensor 30 may be designed to interface with a main board of an application device (such as a smartphone) in which the actuator 100 of the present disclosure is installed, and thus may be installed inside the actuator 100 of the present disclosure, specifically the housing 110, but the image sensor 30 may be installed outside at a position corresponding to an opening formed in the lower portion (based on the Z-axis) of the housing 110 as illustrated in the drawings.

Meanwhile, as illustrated in FIG. 16, the carrier 120, 130 on which an individual lens 60, 70 is mounted may be provided in plurality. In addition, as illustrated in FIG. 16, a fixed lens 50 may be provided at the front of the actuator 100 to improve optical performance, such as the zoom magnification, of the actuator 100.

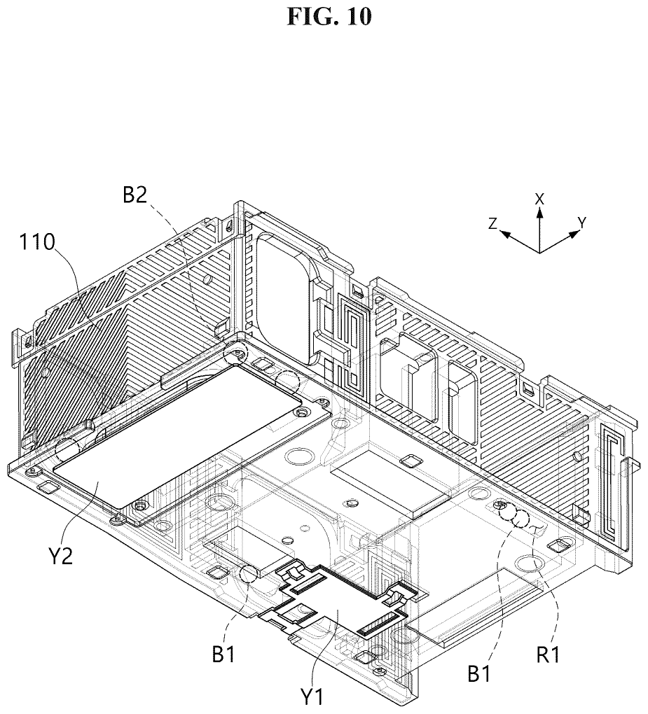

The reflector module 200 in which the reflector 210 is installed may be configured as an independent module. Depending on an embodiment, a yoke plate Y2 (see FIG. 10) that prevents magnetic force leakage and allows the magnetic force (electromagnetic force) to be concentrated on the magnet may be provided in the actuator 100 of the present disclosure.

It is obvious that the axes depicted in the drawings, terms referring to the axes, and terms such as upper, lower, front, rear, vertical, horizontal, etc., described with respect to the axes are only intended to present relative standards for describing embodiments of the present disclosure, and are not intended to specify any direction or position on an absolute basis, and may vary relatively depending on the position of the target object, the position of the observer, the view direction, etc.

FIG. 5 is a drawing for explaining a detailed configuration of the actuator 100 according to the present disclosure. As shown in FIG. 5, the actuator 100 of the present disclosure may include a housing 110 that corresponds to a basic skeleton or frame structure of the actuator 100 and accommodates internal components, and a carrier 120 on which a lens L that emits light to an image sensor 30 is mounted.

The carrier 120 of the present disclosure, on which the lens L is mounted, corresponds to a mover that moves linearly in the optical axis direction (Z-axis direction) due to the magnetic force (electromagnetic force) between the first magnet M1, which is a driving magnet, and the first coil C1, and from a corresponding viewpoint, the housing 110 that supports the linear movement of the carrier 120 corresponds to a relative stator.

The carrier 120 is equipped with a first magnet M1. The housing 110 is equipped with a first coil C1 that faces the first magnet M1 and provides a driving force to the first magnet M1.

If power of an appropriate magnitude and direction is applied to the first coil C1 by the control of the operation driver D, a magnetic force (electromagnetic force) is generated between the first coil C1 and the first magnet M1, and the carrier 120 moves forward and backward in the optical axis direction by the generated magnetic force (electromagnetic force).

If the carrier 120 moves linearly in the optical axis direction (Z-axis direction) in this way, the lens L mounted on the carrier 120 also moves linearly in the optical axis direction, thereby implementing the AF or zoom function.

A first ball B1 (see FIG. 6, etc.) may be placed between the carrier 120 and the housing 110 so that the carrier 120 may linearly move more flexibly with minimized friction. It is preferable that the first ball B1 is placed on a plurality of rails R1, R2 provided on at least one of the carrier 120 and the housing 110.

To effectively guide the linear movement of carrier 120, it is desirable that the first ball B1 is configured to be partially accommodated in the rails R1 and R2.

If the first ball B1 is placed between the carrier 120 and the housing 110 in this way, the carrier may linearly move more flexibly due to minimized friction caused by rolling, moving, rotation, point contact of the ball with a facing object, etc., and it may have the advantages of noise reduction, minimization of driving force, and improved driving precision.

The first coil C1, the operation driver D, etc. described above may be mounted on the circuit board 170, and it is preferable that the circuit board 170 is configured to be partially or entirely exposed to the outside for interfacing with external modules, power supplies, external devices, etc.

Hereinafter, the structure of the rails R1, R2, etc. according to a preferred embodiment of the present disclosure will be described in detail.

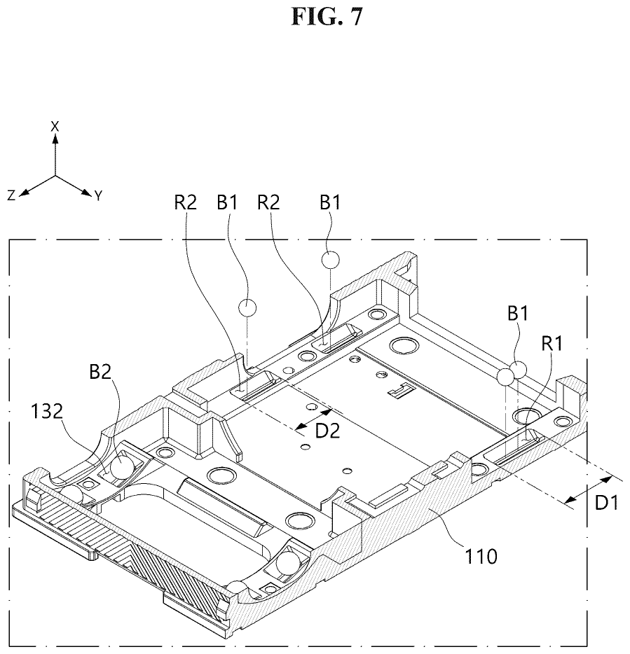

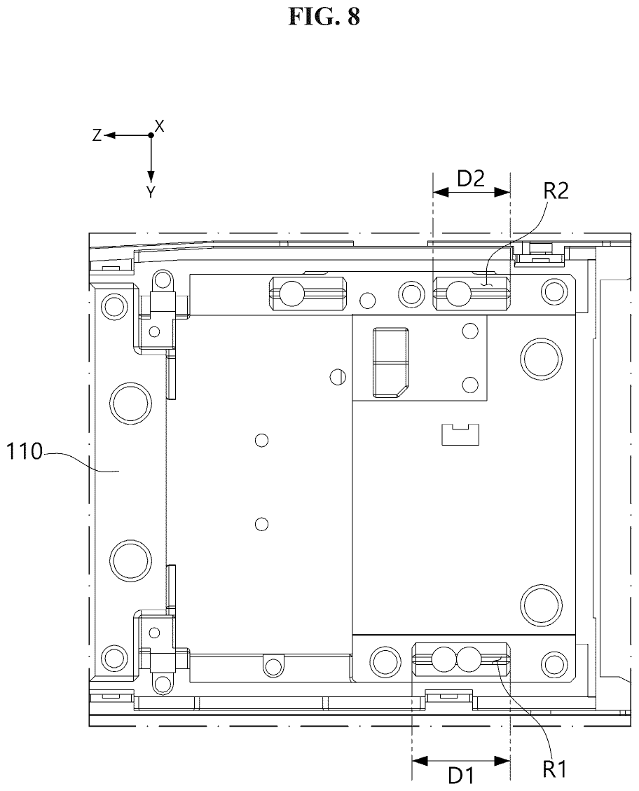

FIG. 6 is a drawing for explaining a detailed configuration of the first ball B1 and the rails R1, R2 according to an embodiment of the present disclosure, and FIGS. 7 and 8 are drawings for explaining a detailed configuration of the first ball B1 and the rails R1, R2 according to another embodiment of the present disclosure.

The actuator 100 according to the present disclosure may include a plurality of rails R1, R2 having a shape extending in a direction corresponding to the direction in which the carrier 120 moves linearly. The plurality of rails R1, R2 may be provided on at least one of the carrier 120 and the housing 110, and the first ball B1 is arranged on each of the plurality of rails R1, R2.

In order to effectively achieve movement of the first ball B1 and linear movement of the carrier 120 physically supported by the first ball B1, the rails R1 and R2 may be formed in a shape in which the groove extends in the length direction (Z-axis direction) as shown in the drawings.

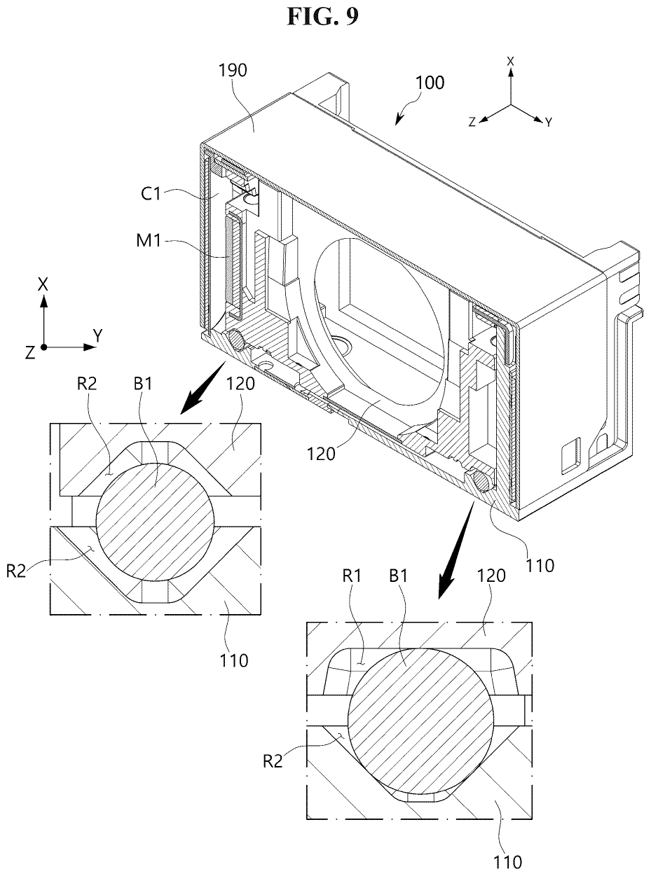

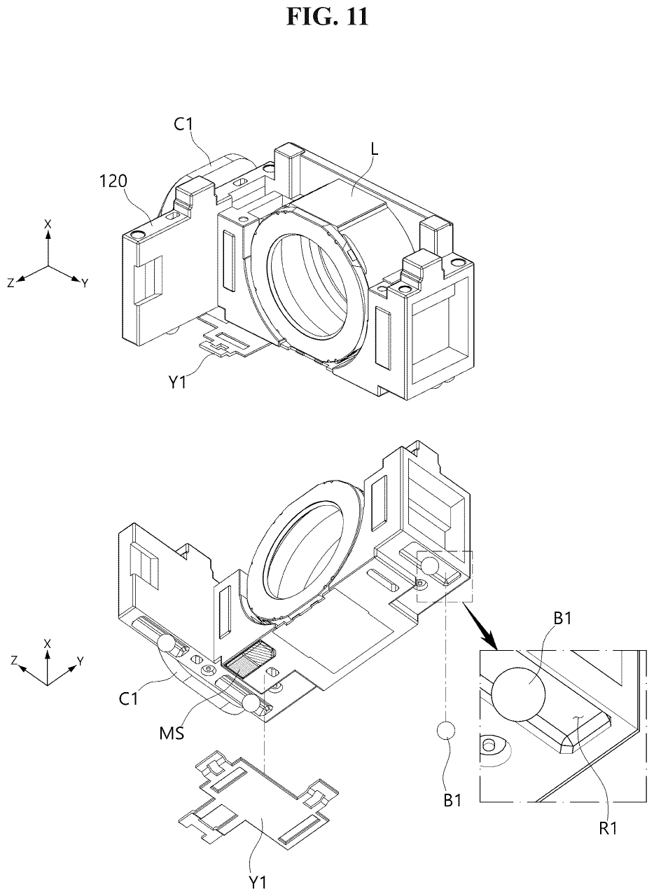

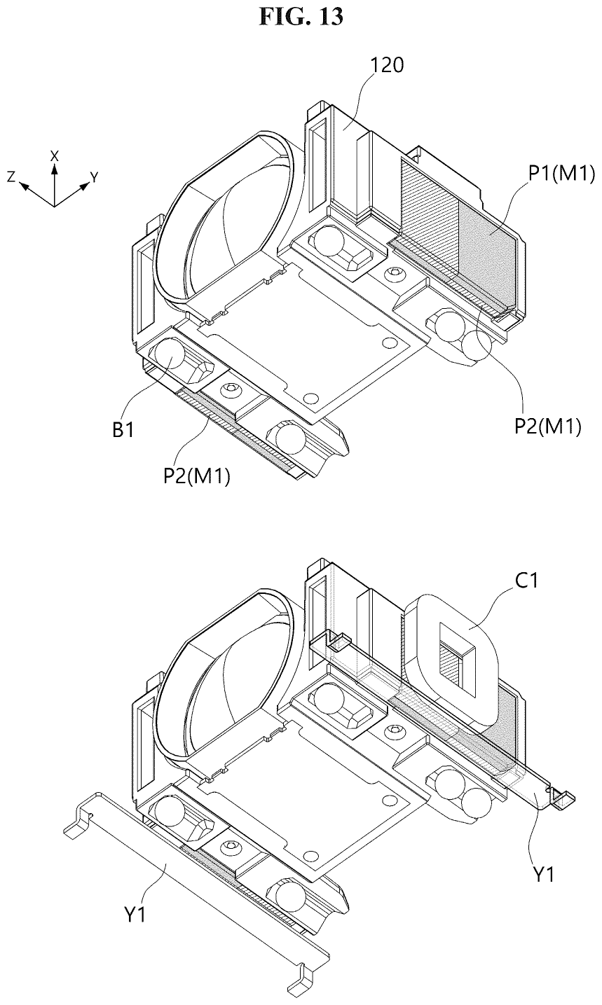

FIGS. 6 to 8 show the rails R1 and R2 provided in the housing 110, FIG. 9 shows the rails R1 and R2 provided in both the housing 110 and the carrier 120, and FIGS. 11 and 13 show the rails R1 and R2 provided in the carrier 120.

As shown in the drawings, the rails R1 and R2 may be provided to face each other on each of the carrier 120 and the housing 110, but depending on an embodiment, the rails R1 and R2 may be provided on only one of the carrier 120 and the housing 110. In this case, in the configuration in which the rails R1 and R2 are not provided, a groove or pocket portion for accommodating the first ball B1 or preventing the first ball B1 from being released externally may be provided.

The plurality of rails R1, R2 may be distributed and arranged at a plurality of positions as shown in the drawings for stable support of the carrier 120. As an example, FIG. 6 shows an embodiment in which four rails R1, R2 are provided in the housing 110, and FIGS. 7 and 8 show an embodiment in which three rails R1, R2 are provided in the housing 110.

Accordingly, FIG. 13 shows an embodiment in which four rails R1, R2 are provided in the carrier 120, and FIG. 11 shows an embodiment in which three rails R1, R2 are provided in the carrier 120.

At least one more first ball B1 may be arranged on the plurality of rails R1, R2 than the number of first balls B1 arranged on the other rail.

In this embodiment, physical support for linear movement of the carrier 120 is effectively implemented, and also external forces applied by dropping, shaking, impact, etc. are dispersed, so that damage, breakage, scars, or dents, etc. of the first ball B1 and the part (rail provided on the carrier or the housing) that comes into contact with the first ball B1 may be suppressed.

Hereinafter, among the plurality of rails R1 and R2, the rail on which at least one more first balls B1 is arranged than the number of first balls B1 arranged on the other rail is referred to as a first rail R1, and the rail other than the first rail R1 among the plurality of rails is referred to as a second rail R2.

Even if the balls are designed to have the same diameter (size), since the diameters of the balls cannot perfectly match, even if a plurality of balls are placed on the same rail, all of the balls may not contact the carrier 120 at the same time, and thus, when the carrier 120 moves, the ball that actually contacts the carrier 120 (hereinafter, referred to as “contacting ball”) may change at any time.

The behavioral characteristics of the carrier 120 in which its movement and stop occur randomly, may also be the reason for the phenomenon in which the contacting ball is changed frequently when the carrier 120 moves.

If the ball actually contacting the carrier 120 is frequently changed in this way, poor posture, tilt, etc. of the carrier 120 may become may occur, and as a result, the driving precision of the carrier 120 as well as the optical performance of the actuator, such as image deterioration, may deteriorate.

Two or more first balls B1 may be placed on each rail R1, R2. However, if the number of first balls B1 placed increases, the problem described above may occur.

Therefore, it may be desirable that a plurality of first balls B1 are arranged only on the first rail R1 and one first ball B1 is arranged on the second rail R2.

Since more first balls B1 are arranged on the first rail R1 than on the other rail (second rail R2), it is preferable that the length (in the Z-axis direction based on the drawing) (D1) of the first rail R1 is longer than the length (D2) of the second rail R2 so that a sufficient area is secured for the movement range of the plurality of first balls B1 arranged on the first rail R1 and for the carrier 120 to be physically supported by the plurality of first balls B1.

As illustrated in FIGS. 7 and 11, the first rail R1 is provided on at least one of one side of the lower portion of the carrier 120 and one side of the bottom surface of the housing 110, and the second rail R2 is provided in parallel with the first rail R1 on at least one of the other side of the lower portion of the carrier 120 and the other side of the bottom surface of the housing 110, and it is preferable that a plurality of second rails R2 are provided on the same line.

If the first rail R1 and the second rail R2 are provided in this way, the area where the carrier 120 is physically supported may be separated and distributed to three places overall, thereby effectively implementing stable support and linear movement of the carrier 120.

In addition, the diameter of the first ball B1 arranged on each of a plurality of (two based on FIG. 7) second rails R2 may be larger than the diameter of the first ball B1 arranged on the first rail R1.

If the diameters of the first balls B1 respectively arranged on the first rail R1 and the second rail R2 are differentiated according to the rails R1 and R2 in this way, the first ball B1 arranged on the second rail R2 in a single quantity and relatively spaced apart may be induced to always contact the carrier 120, and the contact change may be induced to occur only by the first balls B1 arranged in two or more quantities on the first rail R1.

This structure may have a problem of some reduction in driving precision due to the possibility of minute contact changes, but since the contact change is minimized and the range in which the contact change occurs may be predicted, it may be sufficiently controlled through correction algorithms, etc.

In the case of an actuator having a structure in which the carrier is fixedly supported by three balls, it is useful in that it does not cause a change in contact point, but in the case of an actuator having a long stroke such as a zoom drive actuator, a fatal disadvantage may occur in which the three ball support itself collapses depending on the position of the moving carrier, the acceleration of the carrier, or the irregular stopping and moving of the carrier.

In the case of the embodiment of the present disclosure described above, the contact change may be induced to occur only in a plurality of first balls B1 arranged on the first rail R1, so that the carrier 120 may be supported more stably in a long stroke environment such as a zoom drive in a state where the contact change itself is minimized.

In this configuration of the present disclosure, the two points (first ball B1 of the second rail R2) forming the lower side of the trapezoid (relatively long distance) always contact the carrier 120, and the two points (a plurality of first balls B1 of the first rail R1) forming the upper side of the trapezoid (relatively short distance) contact the carrier 120 variably.

Therefore, in this configuration of the present disclosure, the carrier 120 may be supported more stably in a long stroke environment such as a zoom drive.

In addition, in this structure of the present disclosure, when an external force is applied, the impact of the external force is dispersed by the plurality of first balls B1 provided on the first rail R1, so that the occurrence of wear, damage, dents, etc. may be minimized.

In this respect, it is desirable to support a structural design that induces the area where the external force is applied to be the area of the second rail R2 rather than the area of the first rail R1, if possible, when an external force occurs. This will be described later.

FIG. 9 is a drawing for explaining a structure of the rails R1, R2 provided in a housing 110 and a carrier 120, and FIG. 10 is a drawing for explaining a structure of a magnetic body Y1 according to an embodiment of the present disclosure.

Regarding the rails R1 and R2 on which the first ball B1 is placed, one of the first rail R1 and the second rail R2 may be configured such that its cross-section (vertical cross-section based on the optical axis direction) has a “V” shape, and the other may be configured such that its cross-section has a “U” shape.

If the cross sections of the first rail R1 and the second rail R2 are configured to have different geometrical characteristics in this way, the contact area with the first ball B1 and the rotational characteristics may be configured differently, thereby improving the driving characteristics, such as the linear movement and driving efficiency of the carrier 120 moving in the optical axis direction.

If the second rail R2 having a “V-shaped” cross-section is provided on both the carrier 120 and the housing 110, the second rails R2 are arranged so that the wide areas of the grooves face each other, and the first ball B1 is arranged between them. Therefore, the first ball B1 makes point contact with both the second rail R2 of the carrier 120 and the second rail R2 of the housing 110, and the carrier 120 moves linearly due to this contact relationship.

Here, the cross-section being formed in a ‘V shape’ means not only the shape of the alphabet V, but also a shape in which the ball meets the inside of the rail at two points. The cross-section being formed in a ‘U shape’ means not only the shape of the alphabet U, but also a shape in which some amount of free space may exist between the ball and the rail.

If the cross-section of the second rail R2 provided on one of the carrier 120 and the housing 110 is U-shaped, it may be desirable for the linear movement of the carrier 120 to configure the cross-section of the second rail R2 provided on the other to be V-shaped.

As an example, the drawings show an embodiment in which both the first and second rails R1 and R2 provided in the housing 110 have a V-shaped cross-section, the second rail R2 provided on the carrier 120 has a V-shaped cross-section, and the first rail R1 provided on the carrier 120 has a U-shaped cross-section.

As described above, it may be desirable to configure that the first ball B1 placed on the second rail R2 always contacts the carrier 120, and the plurality of first balls B1 placed on the first rail R1 variably contact the carrier 120.

In this case, as illustrated in the drawings, in order to effectively provide physical support and movement guiding by the first ball B1 arranged on the second rail R2, it may be desirable that the second rail R2 is configured to have a V-shaped cross section, and the first rail R1, on which the first ball B1, which variably contacts the carrier 120, is arranged, is configured to have a U-shaped cross section.

As described above, in an embodiment in which the first rail R1 is provided in both the carrier 120 and the housing 110, it is also possible that only one of the first rail R1 provided in the carrier 120 and the first rail R1 provided in the housing 110 may be configured to have a U-shaped cross section.

If the cross-section of the rail is V-shaped, the balls are in point contact with the rail, so there is almost no clearance between the ball and the rail. However, if the cross-section of the rail is U-shaped, clearance may occur between the ball and the rail.

Therefore, when external force is applied, there is a high possibility that the balls placed on the U-shaped rail will be damaged, worn, or dented.

In order for these problems to be structurally reflected, it is desirable that a plurality of first balls B1 capable of dispersing the impact caused by external force are arranged on the first rail R1, which is a rail with a U-shaped cross-section.

The carrier 120 of the present disclosure may include a first magnetic body MS (see FIG. 11), and the housing 110 may include a magnetic body Y1 that is provided to face the first magnetic body MS and generates an attractive force with the first magnetic body MS.

At least one of the first magnetic body MS and the magnetic body Y1 may be made of a magnet, but considering the driving efficiency and the movement range of the carrier 120, it is preferable that the first magnetic body MS provided to the carrier 120, which is a mover, is made of a magnet, and the magnetic body Y1 provided to the housing 110 is made of a magnetic plate (such as metal) with a length extending in the direction in which the carrier 120 moves, as illustrated in the drawings.

If an attractive force or suction force is generated between the first magnetic body MS and the magnetic body Y1, the carrier 120 comes into close contact toward the housing 110 (in the X-axis direction based on the drawings) in a state where the first ball B1 is interposed between the carrier 120 and the housing 110, so that physical contact may be maintained between the first ball B1 and the carrier 120 as well as between the first ball B1 and the housing 110.

As described above, in order to induce the first ball B1 placed on the second rail R2 to always contact the carrier 120, it is preferable that the first magnetic body MS installed on the carrier 120 is located relatively closer to the second rail R2 than to the first rail R1.

In addition, if the first magnetic body MS and the magnetic body Y1 are installed to be biased toward the second rail R2, the adhesion between the carrier 120 and the housing 110 with the first ball B1 placed on the second rail R2 being interposed therebetween may be relatively increased.

Therefore, when an external force is applied to the actuator 100, the impact caused by the external force, etc. on the first ball B1 arranged on the second rail R2, i.e., the first ball B1 that actually guides the linear movement of the carrier 120, may be reduced or weakened.

The first ball B1 placed on the first rail R1 has relatively weaker adhesion than the first ball B1 placed on the second rail R2, and thus can be relatively more affected by external impact. However, as described above, since multiple first balls B1 are placed on the first rail R1, the external impact can be effectively dispersed.

The first ball B1 placed on the first rail R1 has relatively weaker adhesion than the first ball B1 placed on the second rail R2, and thus may be relatively more affected by external impact. However, since a plurality of first balls B1 are placed on the first rail R1 as described above, the external impact may be effectively dispersed.

The linear movement of the carrier 120 is mainly guided by the second rail R2, which is provided in plurality on the same line, and the first ball B1 arranged on the second rail R2. Therefore, in order to minimize the load according to the linear movement, it is preferable that the first magnet M1, which is a driving magnet installed on the carrier 120 and faces the first coil C1, is installed closer to the second rail R2 than to the first rail R1.

In other words, the second rail R2 is arranged at a position close to the location where the first magnet M1, which is a driving magnet, is located, and the first rail R1 is arranged in parallel with the second rail R2, but it is preferable that the second rail R2 is arranged at a position relatively further away from the first magnet M1 than the first rail R1.

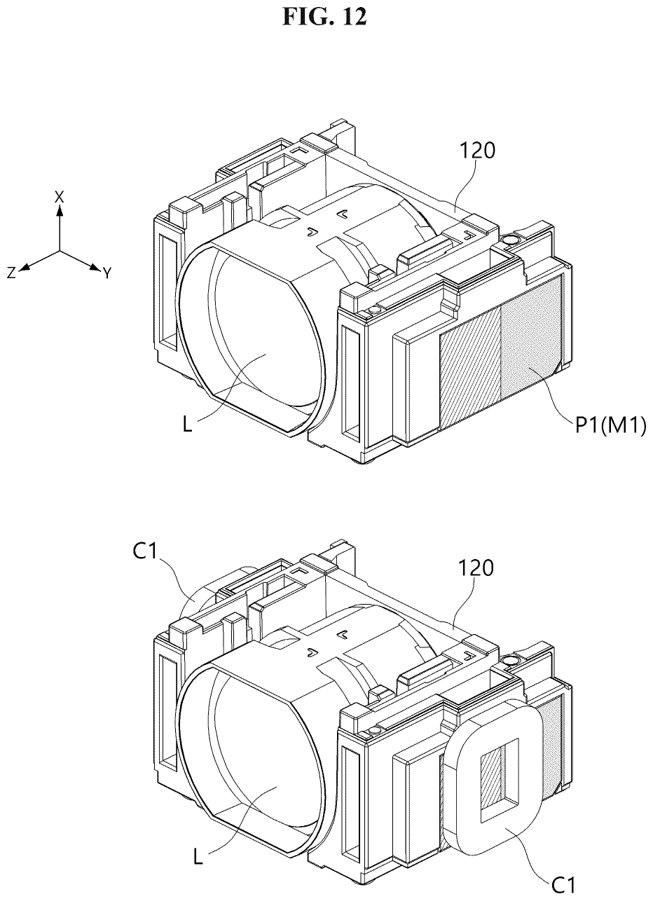

FIG. 11 is a drawing for explaining a carrier 120 according to an embodiment of the present disclosure, and FIGS. 12 and 13 are drawings for explaining a structural relationship between a first magnet M1 and a magnetic body Y1 according to an embodiment of the present disclosure.

FIG. 11 is a drawing showing a carrier 120 on which the rails R1 and R2 corresponding to the rails R1 and R2 of the housing 110 described above with reference to FIGS. 7 to 9 are installed, and FIGS. 12 and 13 are drawings showing a carrier 120 on which the rails R1 and R2 corresponding to the rails R1 and R2 of the housing 110 described above with reference to FIG. 6 are installed.

FIG. 11 shows an embodiment of a carrier 120 in which a single first rail R1 and a dualized second rail R2 are installed side by side in a direction corresponding to the moving direction of the carrier 120.

As described above, the first coil C1, etc., which drives the linear movement of the carrier 120, is placed closer to the second rail R2 than to the first rail R1, and the first magnetic body MS and the magnetic body Y1, which generates an attractive force on the first magnetic body MS, are also preferably installed to be biased closer to the second rail R2 than to the first rail R1.

The first rail R1 shown in FIG. 11 has a U-shaped cross-section. As described above, in this case, the first rail R1 installed in the housing 110 to face the first rail R1 installed on the carrier 120 may have a V-shaped cross-section.

The branch extending laterally from the body of the magnetic body Y1 installed in housing 110 is configured to improve coupling strength with the housing 110 in injection molding, etc.

In addition, the space formed in the upper and lower portions (based on the Z-axis) of the body of the magnetic body Y1 is configured to induce a relatively small attractive force between the first magnetic body MS of the carrier 120 and the magnetic body Y1 when the carrier 120 moves upward or downward (based on the Z-axis), and to induce a relatively large attractive force to be generated in the center portion of the magnetic body Y1.

That is, the structure of the magnetic body Y1 may provide a force to cause the carrier 120 to return to the center portion of the magnetic body Y1 when the carrier 120 moves to the top or bottom.

Through this structure, the magnetic body Y1 of the present disclosure may suppress the carrier 120 from colliding with the housing 110, etc. toward the top or bottom of the movement range (stroke), and also weaken the force applied by the collision.

As shown in FIGS. 12 and 13, a first magnet M1 may be installed on each of both sides of the carrier 120 to enhance driving force, etc., depending on an embodiment.

The first surface P1 of the first magnet M1 is exposed in a direction facing the first coil C1 as shown in the drawings, and the second surface P2, which is a surface of the first magnet M1 that is perpendicular to the first surface P1, is provided in the housing 110 and is configured to be exposed toward the magnetic body Y1 that generates an attractive force with the first magnet M1.

That is, the first magnet M1, which is a driving magnet of the carrier 120 shown in FIGS. 12 and 13, is configured to simultaneously implement the function of driving the movement of the carrier 120 in relation to the first coil C1 and the function of generating adhesion in relation to the magnetic body Y1.

Furthermore, the second surface P2 of the first magnet M1, i.e., the surface facing the magnetic body Y1 provided in the housing 110, is mounted on the carrier 120 to be exposed to the outside, so that the attractive force (adhesion) between the first magnet M1 and the magnetic body Y1 may be increased.

It is preferable that the magnetic body Y1 provided in the housing 110 is configured to have a shape extending in a direction corresponding to the path along which the carrier 120 moves, as shown in FIG. 13.

In addition, it is preferable that the magnetic body Y1 is provided at an outer side than the plurality of rails R1 and R2 so that the physical support of the carrier 120 by the first ball B1 arranged on rails R1 and R2 may be more stably achieved.

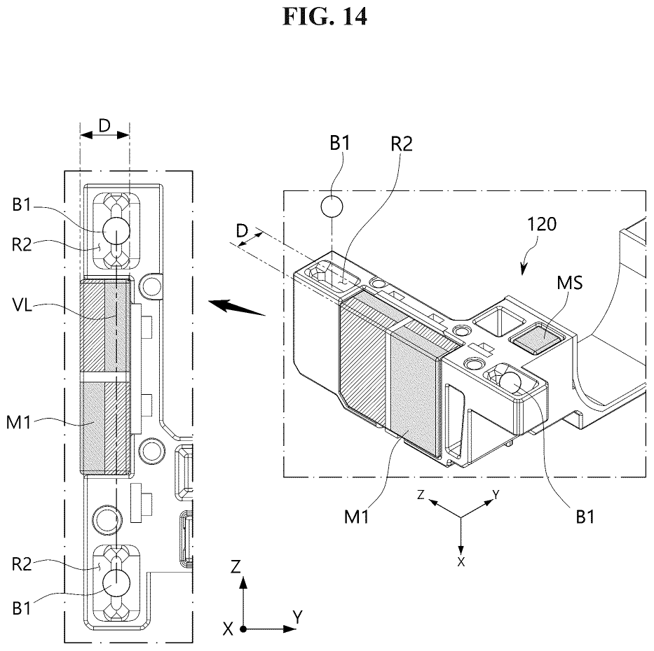

FIG. 14 is a drawing for explaining a relationship between the first magnet M1, which is a driving magnet, and the first ball B1 according to an embodiment of the present disclosure.

As described above, the linear movement of the carrier 120 is mainly guided by the second rail R2, which is provided in plurality on the same line, and the first ball B1 arranged on the second rail R2. In order to organically couple with the driving force, it is preferable that the first magnet M1, which is the driving magnet mounted on the carrier 120, is installed at a location where the second rail R2 is installed.

The driving force that moves the carrier 120 is the magnetic force (electromagnetic force) between the first coil C1 and the first magnet M1, and this driving force acts on the first magnet M1 mounted on the carrier 120, which is a relatively mover.

Therefore, in order to improve driving efficiency and reduce load, it is desirable to configure the structure to minimize the gap or position difference between the structure (second rail R2) that physically supports the moving body carrier 120 and the target (first magnet M1) to which the driving force is applied.

In this respect, as shown in FIG. 14, the first ball B1, which physically supports the carrier 120 and guides the linear movement of the carrier 120, specifically, the first ball B1 arranged on the second rail R2, is preferably provided on the lower portion of the carrier 120, and is located within the thickness range D of the first magnet M1 to which the driving force is applied, as shown in the drawings.

That is, the second rail R2 is provided on the lower portion of the carrier 120, and it is preferable that the line VL (imaginarily) connecting the first balls B1 arranged on each of the second rails R2 is provided in an appropriate area that may be located within the thickness range D of the first magnet M1.

As shown in FIG. 14, the second rail R2 may be provided in two pieces or in plurality, and in this case, it is preferable that the second rails R2 are provided at positions symmetrical to each other with respect to the first magnet M1.

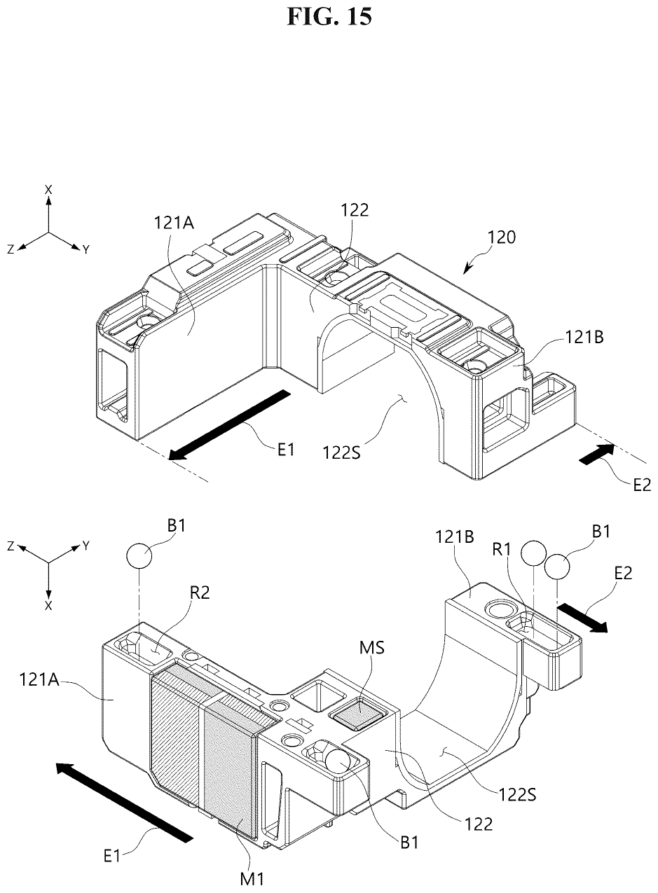

FIG. 15 is a drawing for explaining a structure of a carrier 120 according to another embodiment of the present disclosure.

The carrier 120 according to an embodiment of the present disclosure may include a mounter 122 having a first support portion 121A, a second support portion 121B, and a mounting space 122S in which a lens L is mounted.

As shown in FIG. 15, the first support portion 121A is provided on one of the left and right sides (based on the Y-axis) of the mounter 122 and has a shape (E1) extending in the optical axis direction (Z-axis direction). The first magnet M1, which is a driving magnet, is installed on the first support portion 121A.

The second support portion 121B is provided on the left and right sides of the mounter 122 where the first support portion 121A is not provided, and has a shape (E2) extending in the optical axis direction, but in a direction (the negative Z-axis direction based on FIG. 15) opposite to the direction in which the first support portion 121A extends (the positive Z-axis direction based on FIG. 15).

In this way, if the first and second support portions 121A and 121B extend in the optical axis direction, but in different directions, the physically supported area based on the entire carrier 120 may be expanded, thereby supporting the carrier 120 more stably.

In addition, if the first support portion 121A and the second support portion 121B extend in different directions with respect to the optical axis direction, even if an external impact, etc. is applied, the external impact, etc. may be dispersed more effectively and the amount of physical impact applied to the first ball B1 may be weakened, thereby minimizing wear, damage, dents, etc. that may occur to the first ball B1.

Furthermore, in the embodiment of the present disclosure, since the length or area linearly supported by the first rail R1 and the second rail R2 is expanded, problems such as distortion or tilt of the carrier 120, which deteriorate linearity, may be suppressed more effectively.

Since the first magnet M1, which is a driving magnet, is installed in the first support portion 121A, the driving force between the first coil C1 and the first magnet M1 primarily acts on the first support portion 121A. Therefore, a uniform driving force does not act simultaneously on the entire carrier 120, and a rotational component force may act on the carrier 120.

However, if the first support portion 121A and the second support portion 121B are configured to extend in different directions with respect to the optical axis direction and to increase the distance between the first support portion 121A and the second support portion 121B, as in the embodiment of the present disclosure, the rotational component of the carrier 120 that may occur during the process of transmitting the driving force may be more effectively reduced.

It is preferable that the first rail R1 described above, i.e., the first rail R1 on which one more first balls B1 are placed than the number of first balls B1 placed on the other rail among the plurality of rails, is provided on the lower portion of the second support portion 121B as shown in FIG. 15 for the purpose of weight distribution, stable support, etc.

As described above, the second rail R2 is provided on the lower portion of the first support portion 121A in parallel with the first rail R1, and may be provided in plurality on the same line.

In order to effectively distribute the center of gravity, secure the installation space for the first magnet M1, reduce the space occupied by the entire carrier 120, and effectively suppress the rotational component, it is desirable that the length by which the second support portion 121B extends is smaller than the length by which the first support portion 121A extends (E2<E1).

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

In the above description of this specification, the terms such as “first” and “second” etc. are merely conceptual terms used to relatively identify components from each other, and thus they should not be interpreted as terms used to denote a particular order, priority or the like.

The drawings for illustrating the present disclosure and its embodiments may be shown in somewhat exaggerated form in order to emphasize or highlight the technical contents of the present disclosure, but it should be understood that various modifications may be made by those skilled in the art in consideration of the above description and the illustrations of the drawings without departing from the scope of the present invention.

Reference Symbols

| | |
|---|---|
| 1000: camera module | |
| 100: actuator | 110: housing |
| 120 (130): carrier | |
| 121A (B): first (second) support portion | 122: mounter |
| 170: circuit board | |
| 190: case | 191: opening |
| 200: reflector module | 210: reflector |
| 220: rotation carrier | 230: middle guide |
| 30: image sensor | 50: fixed lens |
| B1: first ball | B2: second ball |
| B3: third ball | C1: first coil |
| C2: second coil | C3: third coil |
| M1: first magnet | M2: second magnet |
| M3: third magnet | D: operation driver |
| Y1: magnetic body | Y2: yoke plate |
| MS: first magnetic body | R1: first rail |
| R2: second rail | |

What is claimed is:

1. An actuator for a camera, comprising:
a carrier configured to move linearly;
a housing configured to support linear movement of the carrier;
a plurality of rails provided on at least one of the carrier and the housing; and
a plurality of balls arranged on each of the plurality of rails,
wherein at least one more ball is arranged on a first rail among the plurality of rails than the number of balls arranged on the other rails.

2. The actuator for a camera according to claim 1,
wherein a length of the first rail is longer than a length of the other rails.

3. The actuator for a camera according to claim 1,
wherein the first rail has a U-shaped cross section.

4. The actuator for a camera according to claim 1, further comprising:
a driving magnet mounted on the carrier;
a coil provided in the housing to face a first surface of the driving magnet; and
a magnetic body provided in the housing to face a second surface, which is a surface of the driving magnet that is perpendicular to the first surface, and configured to generate an attractive force with the driving magnet.

5. The actuator for a camera according to claim 4,
wherein the driving magnet is mounted on the carrier such that both the first surface and the second surface are exposed to the outside.

6. The actuator for a camera according to claim 4,
wherein the magnetic body has a shape extending in a moving direction of the carrier and is provided at an outer side than the plurality of rails.

7. The actuator for a camera according to claim 1,
wherein the first rail is provided on at least one of one side of a lower portion of the carrier and one side of a bottom surface of the housing, and
wherein the plurality of rails include a second rail provided in parallel with the first rail on at least one of the other side of the lower portion of the carrier and the other side of the bottom surface of the housing, and the second rail is provided in plurality on the same line.

8. The actuator for a camera according to claim 7,
wherein the plurality of balls includes:
a ball arranged on the first rail; and
a single ball respectively arranged on the second rail and having a diameter larger than a diameter of the ball arranged on the first rail.

9. The actuator for a camera according to claim 7, further comprising:
a first magnetic body provided on the carrier at a position closer to the second rail than the first rail; and
a second magnetic body provided on the housing to face the first magnetic body and configured to generate an attractive force with the first magnetic body.

10. The actuator for a camera according to claim 7, further comprising:
a coil provided in the housing; and
a driving magnet mounted on the carrier to face the coil and provided at a position closer to the second rail than to the first rail.

11. The actuator for a camera according to claim 8,
wherein an imaginary line connecting centers of the balls placed on the second rail is located within a thickness range of the driving magnet.

12. The actuator for a camera according to claim 1, wherein the carrier includes:
a mounter on which a lens is mounted;
a first support portion provided at one side of the mounter and having a shape extending in an optical axis direction so that the driving magnet is installed thereon; and
a second support portion provided at the other side of the mounter and having a shape extending in the optical axis direction in a direction opposite to the extension direction of the first support portion.

13. The actuator for a camera according to claim 12,
wherein the first rail is provided on a lower portion of the second support portion, and
wherein the plurality of rails includes a second rail provided on a lower portion of the first support portion in parallel with the first rail and provided in plurality on the same line.
